(19) United States
(12) Patent Application Publication
(10) Pub. No.: US 2003/0233237 A1
(43) Pub. Date: Dec. 18, 2003

(54) Integration of speech and stylus input to provide an efficient natural input experience

(75) Inventors: Adrian J. Garside, Sammamish, WA (US); Robert L. Chambers, Sammamish, WA (US); Leroy B. Keely, Portola Valley, CA (US); Charlton E. Lui, Vancouver (CA); Philipp H. Schmid, Mercer Island, WA (US); Kirsten Wiley, Seattle, WA (US); Marieke Iwema, Seattle, WA (US); Ravipal Soin, Bellevue, WA (US); Tobiasz A. Zielinski, Redmond, WA (US); Erik Geidl, Bellevue, WA (US); William H. Vong, Seattle, WA (US)

Correspondence Address: BANNER & WITCOFF LTD.,, ATTORNEYS FOR MICROSOFT, 1001 G STREET , N.W., ELEVENTH STREET, WASHINGTON, DC, 20001-4597, US

(73) Assignee: Microsoft Corporation, Redmond, WA

(21) Appl. No.: 10/174,491

(22) Filed: Jun. 17, 2002

(51) Int. Cl. G10L 21/00

(52) U.S. Cl. 704/270

(57) ABSTRACT

A user interface that accepts input data through both speech and the use of a pen or stylus. With the interface, a user can employ voice recognition to enter a large volume of data, and subsequently employ a stylus input to modify the input data. A user can also employ stylus input, such as data from a handwriting or character recognition operation, to control how subsequently spoken words are recognized by a voice recognition operation. Further, a user may input data using a stylus, and then modify the input data using a voice recognition operation. A user may also employ a voice recognition operation to control how handwriting or character data input through a stylus is recognized by a handwriting recognition operation or a character recognition operation. In addition to a user interface, a technique is disclosed for inputting data into a computer where information is shared between a speech input operation and a handwriting input operation.

### FIELD OF INVENTION

Aspects of the present invention are directed generally to an apparatus and methods for inputting data to a computer through a graphical user interface (GUI) that combines both voice and handwriting recognition. Other aspects of the present invention are directed generally to an apparatus and methods for improving a user's experience from combining speech and stylus input, such as by sharing information between voice recognition operations and handwriting recognition operations.

### BACKGROUND OF THE INVENTION

In the past, users have almost universally input data into computers using physical keyboards, such as the standard QWERTY keyboard. For certain environments, the traditional hardware keyboard has proven to be a very efficient tool for entering data into a computer, particularly when a user has the ability to quickly and accurately employ his or her fingers to type text. As computers have continued to develop and evolve, however, a new generation of computer devices has omitted the use of keyboards for various reasons. For example, a number of household devices, such as refrigerators and stereos, now include a computer of some type, and more types of household devices will incorporate computers in the future. Keyboards cannot easily be incorporated into these household devices in such a way as to be comfortable or convenient for a user. Similarly, hand-held computer devices have foregone a traditional hardware keyboard for smaller size and greater portability. In the next generation of high-powered personal computing devices, many personal computers have also omitted a conventional keyboard with physical keys that may be depressed by a user for the same reason. These newer computer devices instead offer a number of data input tools in lieu of the conventional keyboard.

One pair of frequently used input tools is a stylus and digitizer. As known to those of ordinary skill in the art, when the tip of the stylus (sometimes also referred to as a pen) contacts the surface of the digitizer, the digitizer registers the position of the contact. The digitizer may record the pen's contact by, for example, cameras, lasers, compression of the digitizer surface, a change in an electromagnetic field, or any other suitable method. These tools allow a user to input data into the computer using a variety of techniques. For example, a user may enter raw image data using a stylus and digitizer. That is, a user can employ the stylus to draw an image onto the digitizer. The computer can then store the raw image created by contact points against the digitizer for future manipulation. The image may be any type of drawing, including handwriting, geometric shapes and sketches.

Some computers may also provide a soft keyboard for use with a stylus. A soft keyboard is an arrangement of keys corresponding to those of a conventional keyboard rendered on an interactive display panel (that is, a display panel incorporating a digitizer). The interactive display panel recognizes when a user taps a stylus against a particular location on the display, and registers the character represented at that location of the interactive display as input. The soft keyboard is very accurate, in that it allows a user to unambiguously designate characters to be input to the computer. The soft keyboard is relatively slow for large volumes of text, however, as the user must laboriously “hunt and peck” for each character to be inputted.

Other computer devices may employ individual character recognition. With this technique, the user writes a particular character onto an interactive display or other digitizer with a stylus. The interactive display or digitizer registers the movement of the stylus, and the computer recognizes the character represented by the stylus' movement. Typically, individual character recognition allows a user to input data a little faster than with a soft keyboard, but with less accuracy. Some devices enhance the accuracy of this technique by offering a user various input areas corresponding to the type of character being input. For example, some computers offer one area on the interactive display for a user to input numeric characters, and a second area for a user to input alphabetical characters. While this technique improves the accuracy of the character recognition process, it does not increase the speed at which a user can enter data.

Still other computer devices may employ handwriting recognition to receive data. With this technique, the user writes (either in block print or script) entire words or phrases of input data onto an interactive display or other digitizer. The computer then recognizes text data from the handwriting. This technique will typically allow a user to input data much faster than either using a soft keyboard or individual character recognition. There are a number of drawbacks to this technique, however. Handwriting recognition is much less accurate than either the use of a soft keyboard or individual character recognition. Further, the handwriting recognition operation recognizes text data based upon words that are previously stored in a dictionary. While some handwriting recognition algorithms can recognize words that are not stored in the associated dictionary, recognizing these words requires additional processing time and is subject to greater error. Additionally, if a user inputs large amounts of data at a single time, the user's handwriting will typically become less legible, increasing the error rate in the handwriting recognition process.

In addition to a stylus and digitizer, some computer devices employ microphones to receive data input. For example, some computers may employ voice recognition algorithms to recognize words that are spoken aloud by a user. Voice recognition allows a user to input a large volume of data much more quickly than by using a soft keyboard, character recognition and even handwriting recognition. Moreover, the accuracy of voice recognition improves with use. Still, the overall accuracy of voice recognition algorithms is relatively low when compared to the accuracy of soft keyboards, individual character recognition and handwriting recognition. Further, the accuracy of voice recognition is environmentally dependent. Voice recognition algorithms do not work well in an environment with background noise. Also, like handwriting recognition algorithms, voice recognition algorithms are dictionary based, and have difficulty recognizing words that have not previously been stored in a voice recognition algorithm dictionary.

Thus, while each of the above input techniques provide a number of advantages, none of these techniques provides a natural, streamlined data input process that allows a user to accurately input a large volume of data. There is therefore a need for data input techniques that will allow a user to accurately input data to a computer with both relatively high-speed and accuracy. Further, there is a need for efficient input techniques that will be natural to a user, and thus easily understood and adopted by a user without an inordinate amount of training.

### SUMMARY OF THE INVENTION

Advantageously, the present invention provides efficient and natural input techniques for inputting data into a computer using both a pen and speech. According to some aspects of the invention, a computer provides a single graphical user interface (GUI) that accepts input data through both speech and handwriting. The interface may thus allow a user to employ voice recognition to enter a large volume of data, and subsequently employ textual input entered with a pen or stylus to modify the input data. The interface may alternately permit a user to employ textual input entered with a pen or stylus to control how subsequently spoken words are recognized by a voice recognition operation. The user interface may also allow a user to input data by writing the data with a pen or stylus, and then modify the input data using a voice recognition operation, or employ a voice recognition operation to control how the writing is recognized by a handwriting recognition operation or a character recognition operation.

Aspects of the present invention also provide an efficient and natural input technique for inputting data into a computer where information is shared between a speech input operation and a stylus input operation. For example, with some embodiments of the invention, when a user adds a new word to the handwriting recognition dictionary, the word is also added to the voice recognition dictionary. With other embodiments of the invention, a computer may correlate speech input and pen input created simultaneously, so that a user can later identify the pen input that was created at the same time as specific speech input, or vice versa. For still other embodiments of the invention, a user may employ the pen to timestamp speech input. These and other user input techniques that integrate speech and pen input will be discussed in detail below.

Thus, the present invention allows a user to input data into a computer using speech or through a stylus or pen according to the technique most suitable for the user's abilities and tasks. The invention further allows the user to control the input of the data using either speech or through the use of a stylus or pen, as desired by the user. The user may also modify the data through speech or the use of a stylus or pen according to the user's convenience. A user can therefore submit and subsequently modify input data using any combination of speech or use of a stylus or pen, based on the user's abilities and the task to be accomplished.

These and other features and aspects of the invention will be apparent upon consideration of the following detailed description.

### BRIEF DESCRIPTION OF THE DRAWINGS

The present invention is better understood when read in conjunction with the accompanying drawings, which are included by way of example, and not by way of limitation with regard to the claimed invention.

FIG. 1 shows a schematic diagram of a general-purpose digital computing environment that can be used to implement various aspects of the invention.

FIGS. 2A-2O show the use of a graphical user interface to input data through both voice and handwriting recognition.

FIG. 3 shows a block diagram of the components providing the graphical user interface illustrated in FIGS. 2A-2O.

FIGS. 4A and 4B show embodiments of the invention that share information input between a voice recognition process and a handwriting recognition process.

### DETAILED DESCRIPTION OF THE INVENTION

Overview

The invention relates to the integration of speech and pen input to offer a more natural data input experience. As will be explained in detail below, a user may employ a pen or stylus to input text, make commands, as a pointer, or to input raw image data in conjunction with speech input. Likewise, a user may employ speech input to create text, make commands, as a pointer, or to input raw sound data in conjunction with pen input.

By integrating both speech input and pen input together, a user may enjoy a more natural and efficient input experience. Examples of each of these pen and speech input combinations will be described below.

Exemplary Operating Environment

As will be appreciated by those of ordinary skill in the art, various embodiments of the invention may be implemented using software. That is, the user interfaces and other operations integrating speech and pen input may be described in the general context of computer-executable instructions, such as program modules, executed by one or more computing devices. Generally, program modules include routines, programs, objects, components, data structures, etc. that perform particular tasks or implement particular abstract data types. Typically the functionality of the program modules may be combined or distributed as desired in various embodiments.

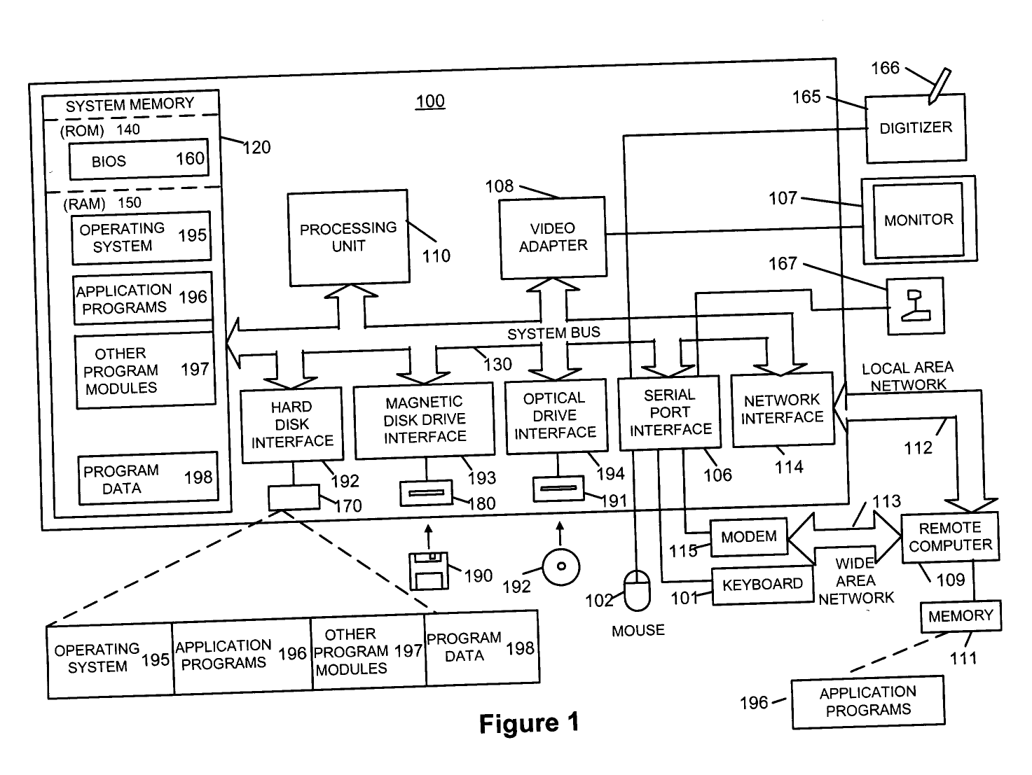

Because various embodiments of the invention may be implemented using software, it may be helpful for a better understanding of the invention to briefly discuss the components and operation of a typical programmable computer on which various embodiments of the invention may be employed. Such an exemplary computer system is illustrated in FIG. 1. The system includes a general-purpose computer 100. This computer 100 may take the form of a conventional personal digital assistant, a tablet, desktop or laptop personal computer, a network server or the like.

Computer 100 typically includes at least some form of computer readable media. Computer readable media can be any available media that can be accessed by a processing unit 110. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the processing unit 110.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connections, and wireless media such as acoustic, RF, infrared and other wireless media. Combinations of any of the above should also be included within the scope of computer readable media.

The computer 100 typically includes a processing unit 110, a system memory 120, and a system bus 130 that couples various system components including the system memory 120 to the processing unit 110. The system bus 130 may be any of several types of bus structures including a memory bus or memory controller, a peripheral bus, and a local bus using any of a variety of bus architectures. The system memory 120 includes read only memory (ROM) 140 and random access memory (RAM) 150. A basic input/output system 160 (BIOS), containing the basic routines that help to transfer information between elements within the computer 100, such as during start-up, is stored in the ROM 140.

The computer 100 may further include additional computer storage media devices, such as a hard disk drive 170 for reading from and writing to a hard disk (not shown), a magnetic disk drive 180 for reading from or writing to a removable magnetic disk 190, and an optical disk drive 191 for reading from or writing to a removable optical disk 192, such as a CD ROM or other optical media. The hard disk drive 170, magnetic disk drive 180, and optical disk drive 191 are connected to the system bus 130 by a hard disk drive interface 192, a magnetic disk drive interface 193, and an optical disk drive interface 194, respectively. The drives and their associated computer-readable media provide nonvolatile storage of computer readable instructions, data structures, program modules, and other data for the personal computer 100.

Although the exemplary environment described herein employs a hard disk drive 170, a removable magnetic disk drive 180 and a removable optical disk drive 191, it should be appreciated by those skilled in the art that other types of computer readable media which can store data that is accessible by a computer, such as magnetic cassettes, flash memory cards, digital video disks, Bernoulli cartridges, random access memories (RAMs), read-only memories (ROMs) and the like may also be used in the exemplary operating environment. Also, it should be appreciated that more portable embodiments of the computer 100, such as a tablet personal computer or personal digital assistant, may omit one or more of the computer storage media devices discussed above.

A number of program modules may be stored on the hard disk drive 170, magnetic disk 190, optical disk 192, ROM 140, or RAM 150, including an operating system 195, one or more application programs 196, other program modules 197, and program data 198. A user may enter commands and information into the computer 100 through various input devices, such as a keyboard 101 and a pointing device 102. As previously noted, the invention is directed to the use of speech input and pen. Accordingly, the computing device 120 will also include a microphone 167 through which a user can input speech information, and a digitizer 165 that accepts input from a pen or stylus 166. Additional input devices may also include, for example, a digitizer, a joystick, game pad, satellite dish, scanner, touch pad, touch screen, or the like.

These and other input devices often are connected to the processing unit 110 through a serial port interface 106 that is coupled to the system bus 130, but may be connected by other interfaces, such as a parallel port, game port, or a universal serial bus (USB). Further still, these devices may be coupled directly to the system bus 130 via an appropriate interface (not shown). A monitor 107 or other type of display device is also connected to the system bus 130 via an interface, such as a video adapter 108. In addition to the monitor 107, personal computers typically include other peripheral output devices (not shown), such as speakers and printers.

The computer 100 may operate in a networked environment using logical connections to one or more remote computers, such as a remote computer 109. The remote computer 109 may be a server, a router, a network PC, a peer device, or other common network node, and typically includes many or all of the elements described above relative to the computer 100, although only a memory storage device 111 with related applications programs 196 have been illustrated in FIG. 1. The logical connections depicted in FIG. 1 include a local area network (LAN) 112 and a wide area network (WAN) 113. Such networking environments are commonplace in offices, enterprise-wide computer networks, intranets, and the Internet.

When used in a LAN networking environment, the computer 100 is connected to the local network 112 through a network interface or adapter 114. When used in a WAN networking environment, the personal computer 100 typically includes a modem 115 or other means for establishing a communications link over the wide area network 113, e.g., to the Internet. The modem 115, which may be internal or external, is connected to the system bus 130 via the serial port interface 106. In a networked environment, program modules depicted relative to the personal computer 100, or portions thereof, may be stored in a remote memory storage device. Of course, it will be appreciated that the network connections shown are exemplary and other techniques for establishing a communications link between the computers may be used. The existence of any of various well-known protocols such as TCP/IP, Ethernet, FTP, HTTP and the like is presumed, and the system may be operated in a client-server configuration to permit a user to retrieve web pages from a web-based server. Any of various conventional web browsers may be used to display and manipulate data on web pages.

User Interface Integrating Speech and Pen Input

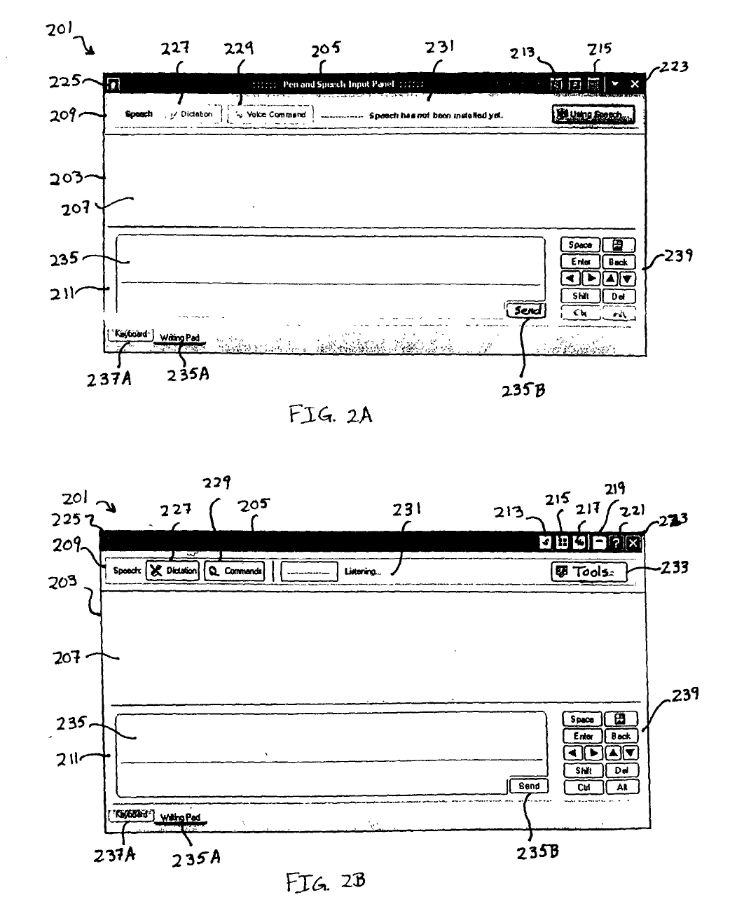

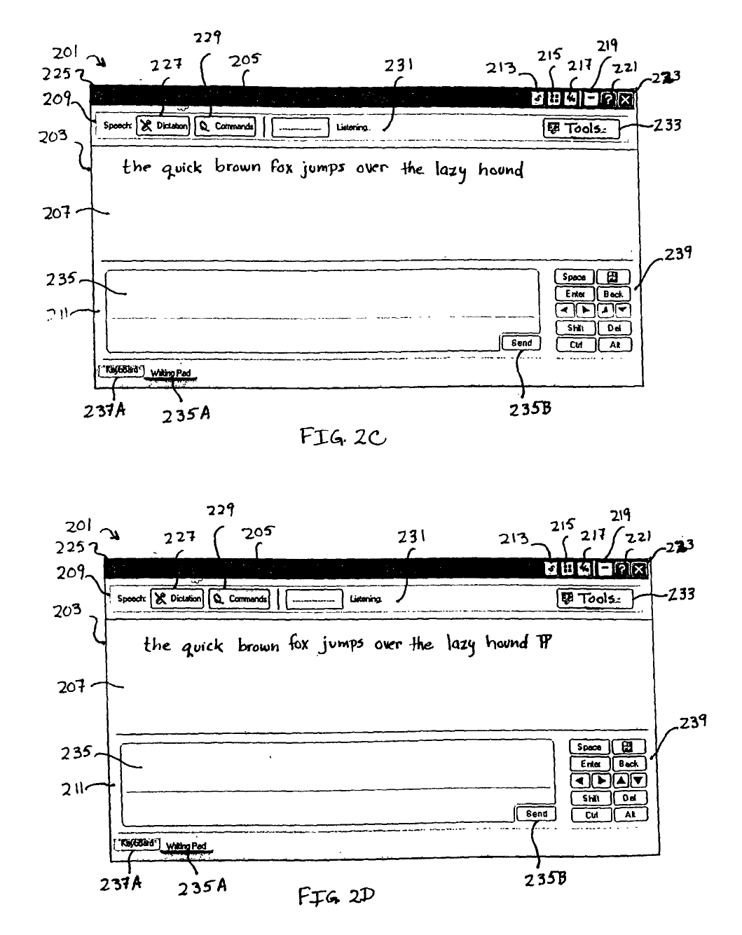

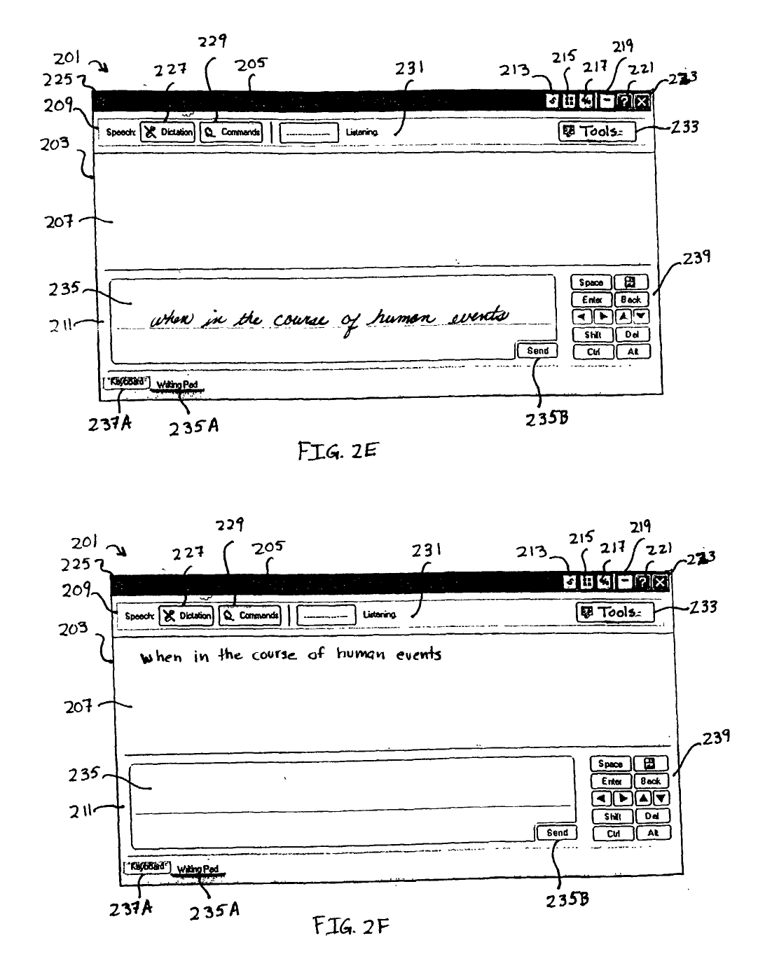

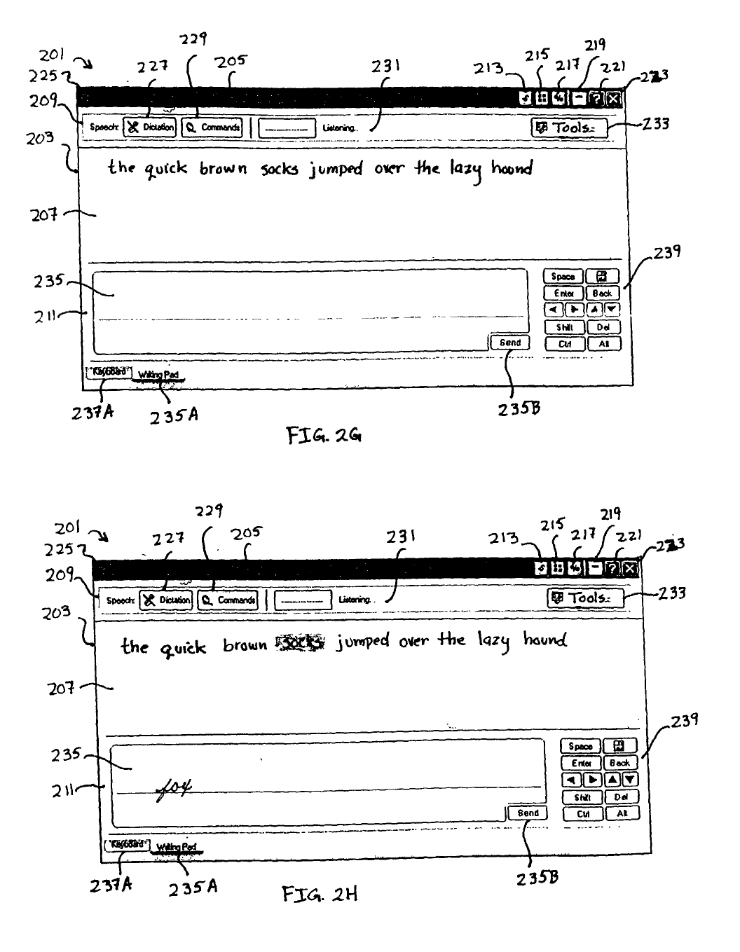

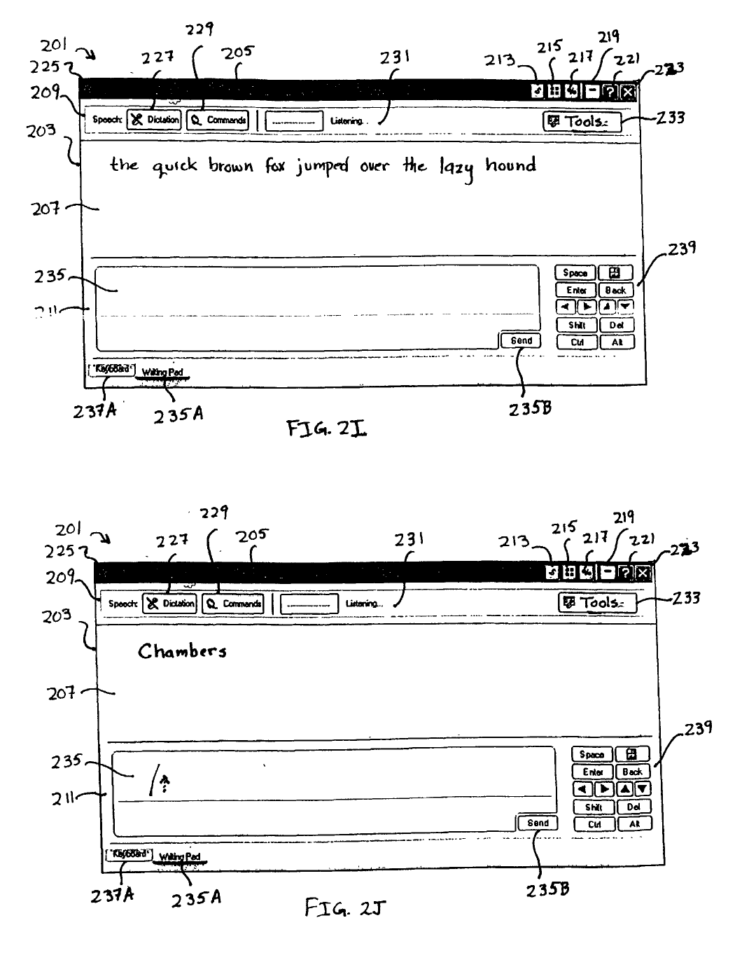

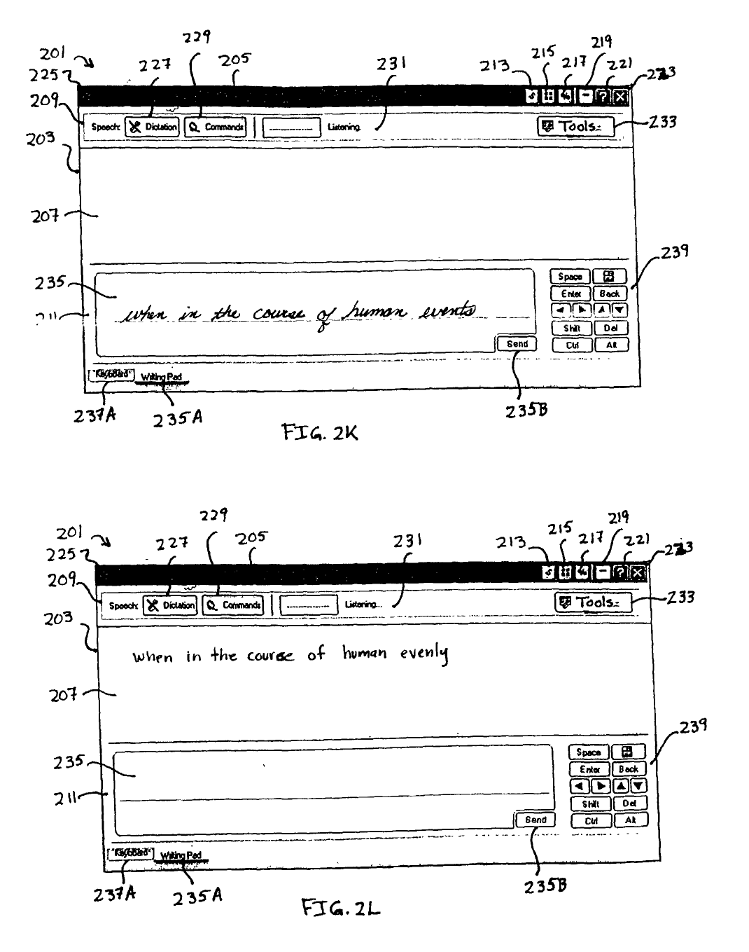

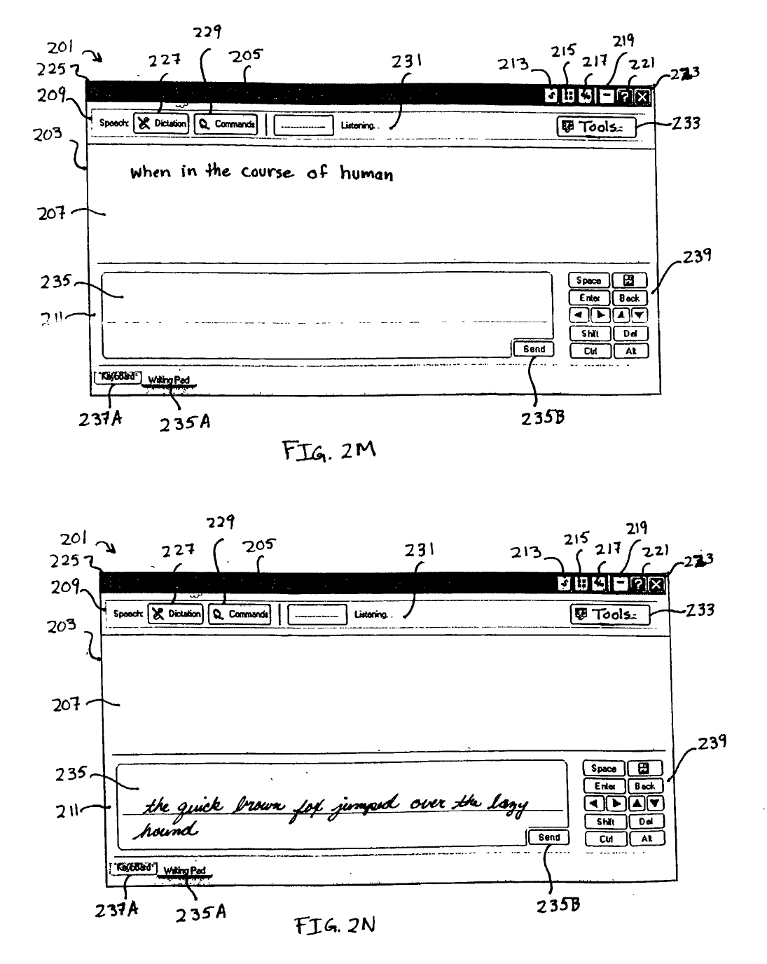

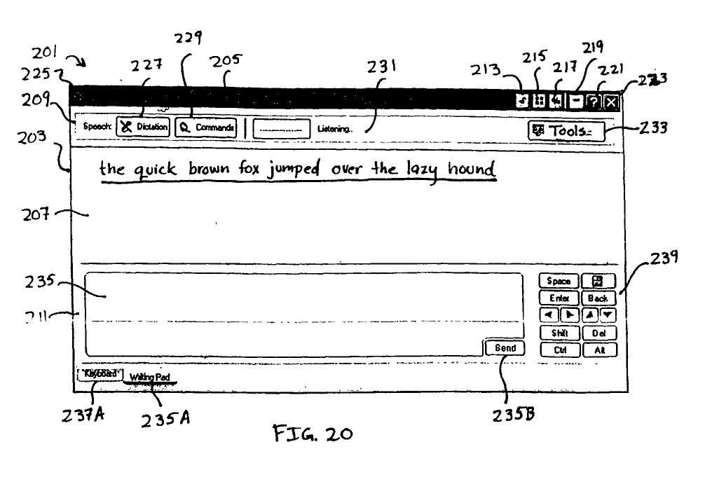

A graphic user interface 201 (GUI) according to one embodiment of the invention is shown in FIG. 2A. The interface 201 defines a window 203 containing a toolbar 205, a corrected text display area 207, a speech input area 209 and a stylus input area 211. As will be explained in detail below, the interface 201 allows a user to input data into a computer using both speech and a stylus. Moreover, the user interface 201 provides proximal and dependable positioning of the speech input area 209 (having buttons and a speech feedback area for controlling and displaying speech input) with the stylus input area 211 (having a writing surface for receiving and displaying stylus input). Thus, the interface 201 provides a user with the ability to consistently position and hide tools for processing speech and pen input together in a single user interface.

The toolbar 205 identifies the user interface 201, and includes a number of command buttons for activating various operations. For example, as illustrated in FIG. 2B, the toolbar 205 may include various command buttons 213, 215, 217, 219 for invoking other user interfaces that may be used with the user interface 201, the help command button 221, and the close window button 223. The toolbar also includes a button 225 to show or hide the stylus input area.

As previously noted, the user interface 201 allows a user to input data into the computer using speech. More particularly, the speech input area 209 assists a user to input data into the computer by speaking the data aloud. The speech input area 209 includes two speech mode buttons 227 and 229. The speech input area 209 also includes a status indicator 231 and a tools activation button 233.

The status indicator 231 indicates the operational status of the voice recognition operation of the user interface 201. For example, as is well known in the art, voice recognition requires an initial training or “enrollment” period where a user must teach the voice recognition algorithm or algorithms to recognize the particular pronunciation and inflection of the user's voice. Accordingly, before the user has trained the voice recognition operation employed by the user interface 201, the status indicator 231 indicates that the speech operation has not yet been installed, as shown in FIG. 2A.

After the voice recognition operation has been trained, the user can activate either of the speech mode buttons 227 and 229 to instruct the user interface 201 to accept input data with voice recognition, as explained in detail below. Upon receiving an instruction to receive input data using voice recognition, the status indicator 233 will then indicate that the user interface is listening for input data, as shown in FIG. 2B. Of course, other embodiments of the invention can employ the status indicator to display a variety of conditions relating to the voice recognition function of the user interface 201. With regard to the tools activation button 233, activating this button provides a drop-down menu of various functions associated with the voice recognition operation of the user interface 201.

As previously noted, activating either of the speech mode buttons 227 or 229 instructs the user interface 201 to accept subsequently spoken words as input data. Activating the dictation speech mode button 227 instructs the interface 201 that all subsequently spoken words should be accepted as text input. For example, if the user activates the dictation speech mode button 227, and subsequently speaks out loud the words “the quick brown fox jumps over the lazy hound,” then the interface 201 will recognize these spoken words using one or more voice recognition algorithms, and treat the results as text. The interface 201 displays this recognized text in the text display area 207, as shown in FIG. 2C. As will be explained in detail below, the text display area 207 advantageously allows the user to correct the text displayed in the area 207 before the text is relayed to another software application as input data.

Alternately, if the user activates the commands speech mode button 229, the computer will attempt to correspond subsequently spoken words with previously determined command operations. More particularly, after the commands button 229 has been activated, the user interface 201 will employ one or more voice recognition algorithms to recognize words subsequently spoken by the user. If a spoken word is recognized to correspond with previously designated command word, the computer performs the operation associated with the recognized command word. For example, after activating the commands button 229, the user may say aloud “new paragraph.” If the interface's voice recognition operation correctly recognizes these words, then the user interface 201 will insert a hard carriage return at the current location of the cursor in the corrected text display area, as illustrated in FIG. 2D.

The stylus input area 211 displays input data received when a user contacts a stylus or pen with a pen digitizer or similar device. With the illustrated user interface 201, the pen digitizer is embodied in the computer's display, so a user can enter input data simply by contacting a stylus with the surface of the display corresponding to the stylus input area 211. It should be noted, however, that the pen digitizer may alternately be embodied in a device separate from the computer's display.

The stylus input area 211 includes a writing pad area 235, accessed through a writing pad tab 235A, and a soft keyboard area (not shown) accessed through a keyboard tab 237A. The stylus input area 211 may also include a keypad 239 presenting a number of command keys including, e.g., “space,” “enter,” “back,” “arrow to the left,” “arrow to the right,” “arrow up,” “arrow down,” “shift,” “delete,” “control,” and “alt,” for performing the same function as their corresponding hard keys on a physical keyboard. As will be appreciated by those of ordinary skill in the art, the user can activate the function of each of the keys on the keypad 239 by contacting or “tapping” the stylus against the portion of the display displaying the key. Similarly, if the user wishes to input data using a soft keyboard, the user may access the keyboard area by activating (i.e., tapping) the keyboard tab 237A.

The user may also employ the stylus to write individual characters or words directly onto the writing pad area 235. For example, as shown in FIG. 2E, the user may write “when in the course of human events” in cursive onto the writing pad area 235. After the user has written a character or an entire word or phrase onto the writing pad area 235, the user can instruct the user interface 201 to recognize the written character or handwriting using a character recognition algorithm or a handwriting recognition algorithm by activating the send button 235B included in the writing pad area 235. The user interface 201 will then recognize the written input, and display the recognized text in the corrected text display area 207, as shown in FIG. 2F.

In addition to writing characters or words, with some embodiments of the invention a user may also employ the stylus to “write” commands or non-printing characters into the writing pad area 235. For example, the user interface 201 may recognize specific movements or gestures with the stylus as a non-printing character, such as “tab” or “hard carriage return.” The user interface 201 may also recognize specific gestures with the stylus as commands to edit data in the text display area 207. Thus, the user interface 201 may recognize a gesture to delete recently entered text from the text display area 207, a gesture to format text recently entered into the text display area 207, or a gesture to paste previously copied text into the text display area 207.

Thus, the graphic user interface 201 integrates the tools for controlling speech input with the tools for controlling pen input. Through the user interface 201, the tools for both speech input and pen input can be simultaneously provided to a user, and the user can reposition or hide those tools together. Still further, the user interface 201 conveniently provides the tools for controlling speech input with the tools for controlling pen input proximal to each other, so that the user may effortlessly switch back and forth between controlling speech input and controlling pen input without having to shift his or her attention between different user interfaces.

Moreover, as will be appreciated by those of ordinary skill in the art, the graphic user interface 201 described above allows a user to concurrently enter data into the computer with a combination of speech and use of a pen, so as to maximize the advantages offered by both input techniques in a way that is more advantageous and convenient to the user and also based on the task to be performed. For example, with the user interface 201, a user can dictate a large amount of text, and then employ a stylus or pen as a pointer, as a tool to input additional text, or to provide commands in order to manipulate the transcribed text.

Discussing these scenarios in more detail, a user may activate the dictation mode button 227 and then dictate a large amount of data. The user interface 201 will employ the voice recognition operation to recognize the words spoken by the user, and then display the recognized words as text in the corrected text display area 207. Because of the inherent inaccuracy of the voice recognition operation, however, there may be one or more errors in the recognition process. This results in the corrected text display area 207 displaying words that were not actually spoken by the user. Thus, the user may speak the words “the quick brown fox jumped over the lazy hound,” for example, but the voice recognition algorithm may erroneously recognize the user's spoken word “fox” as “socks.” The corrected text display area 207 would then erroneously display the phrase “the quick brown socks jumped over the lazy hound” as illustrated in FIG. 2G.

If the user interface 201 were limited to only voice recognition for data input, the user might be required to correct the erroneous recognition of the word “fox” by respeaking the word. If the voice recognition operation did not accurately recognize the word “fox” when originally spoken, however, then there is a lower likelihood that the operation would properly recognize the word when repeated. Advantageously, because the user interface 201 also can receive input from a pen or stylus, the user interface 201 allows a user to correct the word “socks” to “fox” using input from the stylus, rather than voice recognition.

More particularly, the user may employ the stylus as a pointer to select the erroneous word “socks” in the corrected text display area 207 by, e.g., tapping on the word “socks” in the corrected text display area 235 with the stylus. After selecting the word “socks” for correction, the user interface 201 can then provide a drop-down window listing alternate words that sound like “socks,” such as “fox,” “sock,” “sucks,” and “fax.” The user can then employ the stylus to select the correct word from the drop-down menu.

If the word actually spoken by the user is not provided in the list of alternate words, the user may employ the stylus to handwrite the word “fox” in the writing pad area 235, as shown in FIG. 2H. When the user activates the send button 235B, the user interface 201 recognizes the handwriting in the writing pad area 235 as the word “fox,” and changes the display of the selected word “socks” in the corrected text display area 207 to properly display the word “fox,” as shown in FIG. 2I. Of course, the use of a drop-down menu may be omitted, so that a user may correct a word in the corrected text display area 207 by directly writing the corrected word onto the writing pad area 235.

Still further, the user may employ the stylus to give a command for correcting the word socks. For example, the user may use the stylus to write a gesture corresponding to the command “delete,” thereby deleting the work “socks.” Once the incorrect word “socks” was deleted by the gesture, the user could then respeak the word “fox,” rewrite the word “fox” with the stylus, or use the stylus to type the word “fox” with a soft keyboard.

Alternately, the user could employ the stylus as a pointer to enclose the word “fox” with a selection enclosure such as a free-form lasso enclosure, to delete this word before resubmitting the word through the writing area 211, by respeaking the work or through a soft keyboard (not shown).

A user may thus take advantage of the speed and convenience of entering input data into the graphic user interface 201 with speech, and subsequently correct any inaccuracies in the voice recognition process by using the stylus. Of course, while the above example describes the correction of only a single word, it will be appreciated that, with some embodiments of the invention, stylus input may be used to correct larger sets of dictated text, such as sentences or phrases, or smaller sets of dictated text, such as individual characters.

The user can also employ various embodiments of the graphic user interface 201 to control how the voice recognition operation recognizes speech by using the stylus. This feature may be useful where, e.g., the user is dictating text using the voice recognition process and desires to specify the format of how the text should be recognized while dictating. For example, the user may wish to capitalize some of the dictated text, underline some of the dictated text, and bold some of the dictated text. The user may also wish to break the dictated text into paragraphs or distinct pages during dictation.

Advantageously, the user may enter a command for a desired text format during dictation by writing the command onto the writing pad area 235 with the stylus. When the handwriting recognition operation of the user interface 201 recognizes the command, the appropriate words spoken and recognized subsequent to the entry of the handwritten command will be displayed in the corrected text display area 207 with the selected format. For example, if the user wanted to capitalize a word, the user might handwrite the command “capitalize this” in the writing pad area 235. The user would then activate the send button 235B to have the user interface 201 recognize the command “capitalize this,” and the user interface 201 would capitalize the dictated word spoken after the command had been recognized. Of course, in addition to format commands, various embodiments of invention may accept a number of desired handwritten commands for controlling the operation of the voice recognition process, such as editing commands like block, copy, move and paste.

While commands for controlling the operation of the voice recognition process may be entered using handwriting, as previously noted a user may more conveniently and efficiently enter these commands using an individual character recognition process. More particularly, the user interface 201 may recognize specific strokes, referred to as a gesture, made in the writing pad area 235 with the stylus as corresponding to commands for controlling the operation of the voice recognition process. The user interface 201 may, e.g., recognize an upstroke to indicate capitalization of a word spoken immediately following the recognition of the stroke. Similarly, the user interface 201 may recognize a left-to-right horizontal stroke as a command to underline subsequently dictated words, and recognize a right-to-left horizontal stroke as a command to end the underlining of dictated words. Again, any number of desired gestures can be provided for editing text in the text display area 207.

Using these embodiments of the invention, the user can easily control how the voice recognition operation recognizes dictated text through the stylus with minimal hand movement. For example, a user may frequently include the proper name “Chambers” in letters, emails, and other correspondence. While the user would desire to have these uses of the name “Chambers” capitalized during dictation, the voice recognition algorithm would not typically distinguish the proper name “Chambers” from the regular noun chambers, and would therefore always display the spoken word “Chambers” as “chambers” in the corrected text display area 207. To control the recognition of the word “Chambers,” the user could write the single upstroke character on the writing pad area 235 with the stylus, as shown in FIG. 2J, just before or simultaneously with speaking the proper name “Chambers.” Upon recognizing the upward stroke as an indication to capitalize the next spoken word, the user interface 201 will recognize that the spoken word “Chambers” should be capitalized in the corrected text display area 207.

With still other embodiments of the invention, the user interface 201 will allow a user to modify text entered with a stylus by using speech input to provide text, make commands, or act as a pointer. For example, the user can write the desired text into the writing pad area 235, and activate the send button 235B to have the handwriting recognition algorithm recognize the handwriting and display the recognized words in the corrected text display area 207. The user can then activate the command mode button 229 to have the user interface 201 recognize subsequently spoken words as commands for modifying the previously recognized text.

Thus, the user may write the phrase “when in the course of human events” in the writing pad area 235 with the stylus, as shown in FIG. 2K. After activating the send button 235B, the user interface 201 will display the words recognized from the handwriting in the corrected text display area 207. If, however, the handwriting recognition algorithm incorrectly recognizes the written word “events” as “evenly,” then the corrected text display area 207 will incorrectly display the phrase “when in the course of human evenly,” as shown in FIG. 2L.

To correct this error, the user may first select the word “evenly” in the corrected text display area 207 by, e.g., tapping on the word with the stylus. The user can then activate the command mode button 229 and speak the word “delete.” The voice recognition operation will recognize the spoken word “delete” as a command to delete the selected word “evenly” from the corrected text display area, as shown in FIG. 2M. The user can then rewrite the word “event” in the writing pad area 235 and activate the send button 235B to correct the phrase in the corrected text display area 207. Alternatively, the user may activate the dictate mode button 227, and dictate the word “event” into the corrected text display area 207. Thus, speech input can be used both to give commands and input text in order to modify text originally provided through stylus input.

Advantageously, the user interface 201 may also permit the user to employ the voice recognition operation of the interface to control how the handwriting recognition operation recognizes handwriting. That is, while writing text in the writing pad area 235, the user may activate the commands mode button 229, and then speak aloud one or more commands to control the recognition of the handwriting in the writing pad area 235.

For example, a user may want to input the words “the quick brown fox jumped over the lazy hound” with underlining into the computer. Using the interface 201, the user can write these words with the stylus in the writing pad area 235, as shown in FIG. 2N. Before activating the send button 235B, the user first activates the commands mode button 229 and subsequently speaks the word “underline.” When the user then activates the send button 235B, the handwriting recognition operation will recognize the words in the writing pad area 235 and the user interface will display the words “the quick brown fox jumped over the lazy hound” as illustrated in FIG. 2O. Of course, with various embodiments of the invention, the user may speak a desired command before writing text into the writing pad area 235, while writing text into the writing pad area 235, or after writing text into the writing pad area 235.

As will also be appreciated by those of ordinary skill in the art, the user interface 201 can be configured to recognize any desired command, including edit commands such as block, copy, paste, and delete, and format commands such as bold, underline, capitalize, and italics. A user may also employ speech input to create non-printed characters for text recognized from handwriting, such as “tab” and “hard carriage return.” Still further, speech commands can be used to provide a language model context for text being provided through stylus input. For example, if a user is writing a universal resource locator (URL) address, the user will not want any spaces in the recognized handwriting. The user can thus speak a command, such as “U-R-L,” to have the handwriting recognition process omit spaces from recognized handwriting following the command.

As discussed in detail above, with the user interface 201 a stylus can be used as a pointer, to provide text, and to make commands in order to modify text obtained from speech input. Similarly, speech input can be used as a pointer, to provide text, and to make commands to modify text obtained from pen input. It should be noted, however, that with some embodiments of the invention, both speech input and pen input can be provided through the interface 201 to give commands simultaneously. For example, one type of input can be used to issue a basic command, and the second type of input can be used to disambiguate that command. Thus, a user may employ a stylus to make a gesture corresponding to the depression of an activation button on a mouse device (that is, corresponding to “clicking” a mouse). The user can then identify the specific activation button that the user wishes to emulate with the gesture (that is, the user can specify whether the click is a “right” click or a “left” click).

Moreover, by accepting commands through both speech and stylus input, the user interface 201 offers a user the opportunity to submit to different commands through different channels. For example, a user may quickly make a gesture corresponding to a “block” command with the stylus, and then delete the selected text by speaking the command “delete.” Advantageously, allowing a user to make commands through both stylus input and speech input greatly expands the reach of the user's control. For example, in order to employ a stylus to issue a command or make a selection, the user must be able to see the relevant object on the display monitor. With the speech command, however, a user need only be able to verbally identify the relevant object in order to manipulate that object. Similarly, with a speech command, the user must typically be able to verbally identify an object to be manipulated. By allowing the user to employ a stylus to make commands, however, a user need only be able to see the object in the display screen.

As explained above, because the user interface 201 according to various embodiments of the invention accepts input through both speech and a stylus, it provides a natural and streamlined technique for inputting data into a computer, such as the computer 100. By allowing a user to simultaneously enter data using both speech and a stylus, the user interface 201 combines the advantages of voice recognition and handwriting and character recognition to overcome the disadvantages inherent in each technique if employed alone. Moreover, the present invention allows a user to mix and match various techniques for inputting and controlling the computer in a way that is most convenient and advantageous to his or her skills as well as to the task the user is attempting to accomplish.

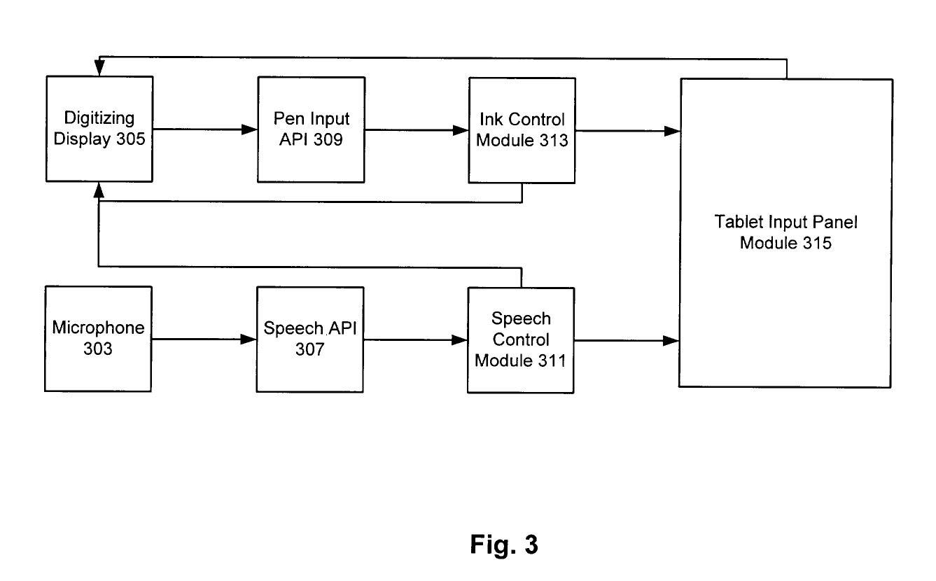

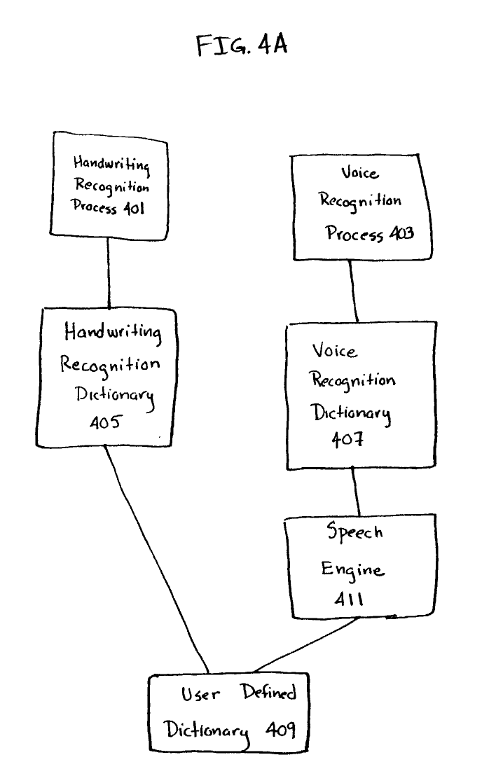

One particular embodiment for implementing the user interface 201 is illustrated in FIG. 3. As seen in this figure, the user interface 201 is provided by an integrated user interface module 301, which receives speech input from a microphone 303 and pen input from a digitizing display 305. More particularly, the microphone 303 records sound samples of a user's speech, and a speech application program interface (API) 307 or other middleware or delivery module conveys the recorded sound samples from the microphone 303 to the integrated user interface module 201. Similarly, stylus input received by the digitizing display 305 is conveyed by a pen application program interface (API) 309 or other middleware or delivery module.

The integrated user interface module 301 contains a speech control module 311, which coordinates various processing functions related to the speech input received from the microphone 303. For example, the speech control module 311 may contain or otherwise employ a voice recognition process for recognizing text from the received speech input. The speech control module 311 may also provide status information for display in the speech input area 209 of the user interface 201. The integrated user interface module 301 also includes an ink control module 313, which coordinates various processing functions related to the pen input received from the digitizing display 305. Thus, the ink control module 313 may contain or otherwise employ a handwriting recognition process for recognizing text from the received pen input. The ink control module 311 may also provide received pen input back to the digitizing display 305 for display in the writing pad area 235.

The integrated user interface module 301 also includes a text input panel module 315, which hosts both the speech control module 311 and the ink control module 313. The text input panel module 315 creates the interface 201 for display in the digitizing display 305. Further, the text input panel module 315 receives recognized text from the speech control module 311 and the ink control module 313. The text input panel module 315 then displays the recognized text in the text display area 207. Further, the text input panel module 315 will forward recognized text onto an appropriate application for insertion. Thus, the integrated user interface module 301 receives and manipulates both speech input from the microphone 303 and stylus input from the digitizing display 305.

Correlation of Information between Speech and Pen Input

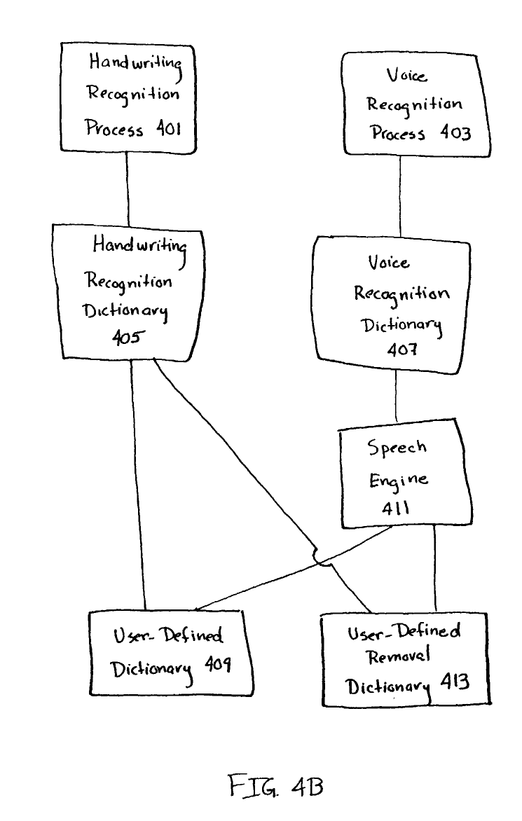

Still other embodiments of the invention integrate speech and pen or stylus input by sharing information between speech input operations and stylus input operations. One example of such an embodiment is illustrated in FIG. 4A. As seen in this figure, the computer includes a handwriting recognition process 401 and a voice recognition process 403. As is well known in the art, the handwriting recognition process 401 recognizes handwriting based upon words stored in a handwriting recognition dictionary 405, while the voice recognition process 403 recognizes spoken words based upon sounds stored in a voice recognition dictionary 407. Conventionally, the voice recognition dictionary 407 stores sound-word combinations, so that the voice recognition process can correlate a spoken sound with a text word.

The computer also has a user-defined dictionary 409, and a speech engine 411. The user-defined dictionary 409 includes words that were not initially included in the handwriting dictionary 405 or the voice recognition dictionary 407, but were subsequently added by a user. The speech engine 411 generates a pronunciation of how a person will speak a text word. As is known in art, pronunciations generated by such a speech engine may be, e.g., 93% accurate, with the remaining 7% of pronunciations being relatively accurate. This allows the speech engine 409 to generate sounds corresponding to a text word. The speech engine 411 then adds the text word with the corresponding generated sound to the voice recognition dictionary 407, so that the voice recognition process 403 can subsequently recognize when the word is spoken aloud.

When the user inputs a word through handwriting, the handwriting recognition process 401 recognizes the handwriting using the handwriting recognition dictionary 405. If the word to be recognized is not in the handwriting recognition dictionary 405, then the user may add the word to the user-defined dictionary 409, and the word is propagated to the handwriting recognition dictionary 405. According to the invention, the newly entered word is also propagated from the user-defined dictionary 409 to the speech engine 411. The speech engine 411 then generates a sound corresponding to the new word, and forwards the sound-word pair to the voice recognition dictionary 407 for future use by the voice recognition process 403. In this manner, information submitted to the computer 100 for use by the handwriting recognition process 401 is shared with the voice recognition process 403.

Similarly, if the user speaks a word aloud, the voice recognition process 403 employs the voice recognition dictionary 405 to recognize the word. If the word is not in the voice recognition dictionary 405, the user may add the word to the user-defined dictionary 409. The newly added word is then propagated to the speech engine 411, which then generates a sound corresponding to the new word and forwards the sound-word pair to the voice recognition dictionary 407. According to the invention, the newly added word is also propagated from the user-defined dictionary 409 to the handwriting recognition dictionary 405 for future use by the handwriting recognition process 401. Thus, information submitted to the computer 100 for use by the voice recognition process 403 is shared with the handwriting recognition process 401.

Still another embodiment of the invention is illustrated in FIG. 4B. This embodiment is similar to the embodiment shown in FIG. 4A, but with this embodiment the computer 100 additionally includes a user-defined removal dictionary 413. This dictionary 413 defines words that will not be recognized by the handwriting recognition process 401 or the voice recognition process 403. When the user desires that the computer 100 not recognize a particular word (i.e., a proper name that the handwriting recognition process 401 and the voice recognition process 403 routinely incorrectly recognize), the user may enter that word into the user-defined removal dictionary 413. The word is then deleted from the handwriting recognition dictionary 405. Similarly, the word is passed to the speech engine 411, which generates a sound corresponding to the word. This generated sound is then deleted from the voice recognition dictionary 407.

With still other embodiments of the invention, a user can employ a speech input to modify the format of raw data obtained from stylus input. For example, if the user is simply drawing in image with the stylus, the invention may allow the user to verbally specify the width, color, or other characteristics of the electronic ink produced through movement of the stylus. Alternately, the stylus may be used as a command device to control the operation of a speech input process obtaining raw speech data. Thus, the user may employ a stylus to activate or deactivate a recording operation for obtaining raw speech data. Also, the user may employ a stylus to time stamp raw data obtained through speech input. For example, a user interface could provide a time stamp button during a recording session for recording speech input. When the user wished to annotate the time at which a particular word or phrase was recorded, the user could simply tap the stylus against the time stamp button to make the annotation.

Still further, various embodiments of the invention may correlate speech input and stylus input received contemporaneously or simultaneously. For example, a user may record the conversation spoken during a meeting. The user may also take handwritten notes with the stylus while the speech input process is recording the conversation. When subsequently reviewing his or her notes, a user might have a question as to what prompted a particular notation. With this embodiment of the invention, the user could playback the speech input obtained when that note was made. Alternately, when listening to the recorded conversation of the meeting, various embodiments of the invention could display the notes taken during the portion of the conversation being played back.

### CONCLUSION

Although the invention has been defined using the appended claims, these claims are exemplary in that the invention may be intended to include the elements and steps described herein in any combination or sub combination. Accordingly, there are any number of alternative combinations for defining the invention, which incorporate one or more elements from the specification, including the description, claims, and drawings, in various combinations or sub combinations. It will be apparent to those skilled in the relevant technology, in light of the present specification, that alternate combinations of aspects of the invention, either alone or in combination with one or more elements or steps defined herein, may be utilized as modifications or alterations of the invention or as part of the invention. It may be intended that the written description of the invention contained herein covers all such modifications and alterations. For instance, in various embodiments, a certain order to the data has been shown. However, any reordering of the data is encompassed by the present invention. Also, where certain units of properties such as size (e.g., in bytes or bits) are used, any other units are also envisioned.

What is claimed is:

1. A user interface for integrating speech and handwriting, comprising:
a speech input portion that allows a user to input data into the computer by speaking words aloud; and
a stylus input portion that allows a user to input data into the computer by writing with a stylus.

2. The user interface recited in claim 1, further comprising a corrected text portion which employs data input through the speech portion to control data input through the stylus input portion, and employs data input through the stylus input portion to control data input through the speech input portion.

3. The user interface recited in claim 1, wherein the speech input portion includes a dictation function that instructs the user interface to recognize words spoken aloud by the user as text.

4. The user interface recited in claim 1, wherein the speech input portion includes a commands function that instructs the user interface to recognize words spoken aloud by the user as commands for controlling operation of the computer.

5. The user interface recited in claim 1, wherein the stylus input portion includes a text function that instructs the user interface to recognize words written by the user as text.

6. The user interface recited in claim 1, wherein the stylus input portion includes a commands function that instructs the user interface to recognize words written by the user as commands for controlling operation of the computer.

7. The user interface recited in claim 1, wherein the user interface simultaneously accepts speech input and writing input.

8. The user interface recited in claim 1, further comprising a corrected text display portion for displaying and correcting text input through the speech input portion and the stylus input portion.

9. A method of integrating speech and handwriting for inputting data into a computer, comprising:
receiving first data input by a user with speech;
receiving second data input by a user with a stylus; and
modifying the first data using the second data, or modifying the second data using the first data.

10. The method of integrating speech and handwriting for inputting data into a computer recited in claim 9, further comprising receiving the first data input by recognizing handwriting written with the stylus.

11. The method of integrating speech and handwriting for inputting data into a computer recited in claim 10, further including treating the first data as text data for generating text, command data for issuing an instruction, or pointer data for identifying a location.

12. The method of integrating speech and handwriting for inputting data into a computer recited in claim 10, further including treating the second data as text data for generating text, command data for issuing an instruction, or pointer data for identifying a location.

13. The method of integrating speech and handwriting for inputting data into a computer recited in claim 10, further including
treating the first data as command data for issuing an instruction, and
treating the second data as command data for disambiguating the instruction.

14. The method of integrating speech and handwriting for inputting data into a computer recited in claim 10, further including
treating the second data as command data for issuing an instruction, and
treating the first data as command data for disambiguating the instruction.

15. The method of integrating speech and handwriting for inputting data into a computer recited in claim 10, further including treating the first data as a command to discontinue receiving the second data.

16. The method of integrating speech and handwriting for inputting data into a computer recited in claim 10, further including treating the second data as a command to discontinue receiving the first data.

17. A method of integrating speech and handwriting for inputting data into a computer, comprising:
receiving speech input from a user;
generating text by recognizing words corresponding to the speech input;
receiving handwriting input from the user;
recognizing at least one word corresponding to the handwriting input; and
modifying the generated text based upon the at least one word recognized from the handwriting input.

18. The method of integrating speech and handwriting recited in claim 17, further comprising modifying the generated text by replacing at least one word in the generated text with the at least one word recognized from the handwriting input.

19. The method of integrating speech and handwriting recited in claim 17, further comprising:
recognizing the at least one word corresponding to the handwriting input as a command; and
modifying the generated text according to the recognized command.

20. The method of integrating speech and handwriting recited in claim 17, wherein the handwriting input is one or more handwritten strokes preselected to correspond with a command.

21. A method of integrating speech and handwriting for inputting data into a computer, comprising:
receiving handwriting input from a user;
generating text by recognizing words corresponding to the handwriting input;
receiving speech input from a user;
recognizing at least on word corresponding to the speech input; and
modifying the generated text based upon the at least one word recognized from the speech input.

22. The method of integrating speech and handwriting recited in claim 21, further comprising modifying the generated text by replacing at least one word in the generated text with the at least one word recognized from the speech input.

23. The method of integrating speech and handwriting recited in claim 21, further comprising:
recognizing the at least one word corresponding to the speech input as a command; and
modifying the generated text according to the recognized command.

24. A method of integrating speech and handwriting, comprising:
providing a voice recognition operation for recognizing speech input;
providing a handwriting recognition operation for recognizing handwriting input; and
sharing recognition information between the voice recognition operation and the handwriting recognition operation.

25. The method of integrating speech and handwriting recited in claim 24, wherein sharing the recognition information includes:
receiving a new word for addition to a voice recognition dictionary for the voice recognition operation; and
adding the new word to a handwriting recognition dictionary for the handwriting recognition operation.

26. The method of integrating speech and handwriting recited in claim 24, wherein sharing the recognition information includes:
receiving a new word for addition to a handwriting recognition dictionary for the handwriting recognition operation; and
adding the new word to a voice recognition dictionary for the voice recognition operation.

27. The method of integrating speech and handwriting recited in claim 24, wherein the recognition information is contained in a recognition dictionary shared by the voice recognition operation and the handwriting recognition operation.

28. A method of integrating speech and pen input, comprising:
receiving speech input;
receiving pen input; and
correlating the received speech input with the received pen input.

29. The method of integrating speech and pen input recited in claim 28, further comprising correlating the received speech input with the received pen input so that the received pen input can be referenced through the received speech input.

30. The method of integrating speech and pen input recited in claim 28, further comprising correlating the received speech input with the received pen input so that the received speech input can be referenced through the received pen input.

31. The method of integrating speech and pen input recited in claim 30, further comprising correlating the received speech input with the received pen input so that the received pen input can be referenced through the received speech input.

32. The method of integrating speech and pen input recited in claim 28, wherein the speech input is a portion of a conversation.

33. The method of integrating speech and pen input recited in claim 32, wherein the pen input is handwriting.

34. The method of integrating speech and pen input recited in claim 32, wherein the pen input is a drawing.

35. The method of integrating speech and pen input recited in claim 28, wherein the speech input is correlated with the pen input by identifying a time value for the speech input designated when the pen input is received.

36. The method of integrating speech and pen input recited in claim 28, wherein the pen input is correlated with the speech input by identifying a time value for the pen input designated when the speech input is received.
